(19) United States
(12) Patent Application Publication
(10) Pub. No.: US 2025/0192548 A1
(43) Pub. Date: Jun. 12, 2025

(54) CAPACITY RECOVERY AND MULTI-SOURCE POWER DISTRIBUTION

(71) Applicant: VERTIV CORPORATION, Westerville, OH (US)

(72) Inventors: Peter A. Panfil, Columbus, OH (US); Timothy K. Easterday, Lewis Center, OH (US); Michael Francis Smith, Westerville, OH (US); Frederick D. Rebarber, Westerville, OH (US)

(21) Appl. No.: 18/842,331

(22) PCT Filed: Mar. 8, 2023
(86) PCT No.: PCT/US2023/014831

§ 371 Date: Aug. 28, 2024

Related U.S. Application Data
(60) Provisional application No. 63/317,676, filed on Mar. 8, 2022.

(51) Int. Cl. H02J 1/08; H02J 1/12; H02J 3/36; H02J 3/46

(52) U.S. Cl. CPC H02J 1/084; H02J 1/12; H02J 3/36; H02J 3/46; H02J 2300/24; H02J 2300/28; H02J 2300/30

(57) ABSTRACT

A power distribution system may include one or more power supply units configured to accept direct current (DC) input power from two or more DC input power sources and provide output DC power at a DC load voltage for distribution to one or more loads, where the DC input power is provided at one or more input DC voltages different than the DC load voltage. The power distribution system may further include one or more alternating current (AC) to DC rectifiers (AC/DC rectifiers) to convert AC input power from one or more AC input power sources to at least one of the one or more input DC voltages, where each of the one or more AC/DC rectifiers is connected to at least one of the one or more power supply units as one of the two or more DC input power sources.

### CROSS-REFERENCE TO RELATED APPLICATION

The present application claims the benefit under 35 U.S.C. § 119 (e) of U.S. Provisional Application Ser. No. 63/317,676, filed Mar. 8, 2022, entitled CAPACITY RECOVERY AND MULTI-SOURCE POWER DISTRIBUTION, naming Peter A. Panfil, Timothy K. Easterday, Michael Francis Smith, and Frederick D. Rebarber, as inventors, which is incorporated herein by reference in the entirety.

### TECHNICAL FIELD

The present disclosure relates generally to power distribution systems and, more particularly, to power distribution from multiple available sources.

### BACKGROUND

Challenging power distribution applications such as, but not limited to, multi-tenant data centers (MTDCs) are facing ever-increasing power demands with high reliability requirements. However, continuously building the new power sources to meet the rising power demands is expensive and cumbersome. Further, it is increasingly desirable to provide power from multiple available sources including, but not limited to, sustainable power sources. There is therefore a need to develop systems and methods for power distribution that cure the above shortcomings.

### SUMMARY

A power distribution system may include two or more input power sources including any combination of alternating current (AC) input power sources or direct current (DC) input power sources, one or more AC/DC rectifiers to convert input power from any of the one or more AC input power sources to DC power, and a power supply unit configured to distribute the DC power to one or more loads. For example, the AC/DC rectifiers may provide high-voltage DC (HVDC) power along one or more DC busways to the power supply unit. Further, the power distribution system may include a DC trunking system to feed HVDC power from any number of DC input power sources to the power supply unit. In this way, the power distribution system may allow for the flexible and dynamic utilization of power from any number of available input sources of any type, which may provide numerous benefits including, but not limited to, capacity recovery of available input power without the need for isolation transformers tailored to particular AC circuits, and seamless integration of sustainable power sources.

A power distribution method may include receiving, with one or more power supply units, DC input power from two or more DC input power sources at one or more input DC voltages, where at least one of the two or more DC input power sources is an alternating current (AC) to DC rectifier (AC/DC rectifier) for converting AC input power from one or more AC input power sources to at least one of the one or more input DC voltages. The method may further include converting, with the one or more power supply units, the one or more input DC voltages to a DC load voltage different than the one or more input DC voltages. The method may further include providing, with the one or more power supply units, output DC power at the DC load voltage for distribution to one or more loads.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1A is a block diagram view of a power distribution system configured to accept power from multiple alternating current (AC) power sources, in accordance with one or more embodiments of the present disclosure.

FIG. 1B is block diagram view of a power distribution system configured to accept power from multiple AC and/or direct current (DC) input power sources, in accordance with one or more embodiments of the present disclosure.

FIG. 1C is block diagram view of a power distribution system in which at least one DC input power source is formed as a hydrogen fuel cell, in accordance with one or more embodiments of the present disclosure.

FIG. 1D is block diagram view of a power distribution system configured to accept AC input power from multiple synchronous AC input power sources, in accordance with one or more embodiments of the present disclosure.

FIG. 2A is a conceptual view of a power distribution system powered by mains power as a primary input power source and a fossil-fuel powered generator as an alternate input power source, in accordance with one or more embodiments of the present disclosure.

FIG. 2B is a conceptual view of a power distribution system powered by mains power as a primary input power source and a hydrogen fuel cell as an alternate input power source, in accordance with one or more embodiments of the present disclosure.

FIG. 2C is a conceptual view of a power distribution system powered by a hydrogen fuel cell as a primary input power source and mains power as an alternate input power source, in accordance with one or more embodiments of the present disclosure.

FIG. 2D is a conceptual view of a power distribution system powered by multiple sustainable input power sources, in accordance with one or more embodiments of the present disclosure.

FIG. 3 is a flow diagram illustrating steps performed in a method for power distribution, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods for flexibly providing power to loads from any of multiple input power sources. In this way, stranded or branched power capacity from any input power source or combination of input power sources may be efficiently utilized. In some embodiments, a power distribution system includes one or more AC/DC rectifiers (e.g., AC/DC converters) to convert AC power from any number of asynchronous AC power input sources to DC power and one or more power supply units (PSUs) to distribute the DC power to various loads such as, but not limited to, server racks. For example, AC/DC rectifiers may provide high voltage DC (HVDC) power (e.g., 240 VDC, 380 VDC, or the like) to the PSU either directly or through one or more DC busways. The PSU may generally provide any suitable voltage to power the loads. For example, the PSU may directly provide the load with the HVDC power (e.g., 240 VDC, 380 VDC, or the like). By way of another example, the PSU may include one or more DC/DC converters to step down the HVDC power to lower voltages suitable for powering the various loads (e.g., 48 VDC, 240 VDC, or any suitable DC load voltage). In some embodiments, the power distribution system further includes a DC trunking system to accept DC power from any number of DC input power sources. In this way, the power distribution system may accept power from sustainable input sources providing DC power. For example, the DC trunking system may include one or more DC/DC converters to convert DC power from the DC input power sources to the HVDC levels received by the PSU. In this way, the PSU may flexibly receive HVDC power from any number of AC or DC input power sources and distribute this power as necessary to various loads.

It is contemplated herein that the systems and methods for power distribution disclosed herein may provide several benefits for challenging power distribution tasks such as, but not limited to, multi-tenant data centers (MTDCs).

Power distribution at MTDCs face multiple challenges. First, advances in server rack technologies including liquid cooling techniques are enabling increased rack densities, which may exceed 10 KW per rack. Second, utilization of available input power (e.g., input AC power) is often low at MTDCs. Third, sustainability initiatives targeting reduced or zero carbon power usage require the flexibility to accept power from sustainable sources. For example, many MTDCs are deploying a two-tiered strategy for achieving sustainability goals including purchasing sustainably-generated input power and replacing existing diesel or other fossil-fuel-based generators with sustainably-powered generators (e.g., hydrogen generators, or the like).

The systems and methods for power distribution disclosed herein may address these challenges. In particular, the systems and methods disclosed herein may facilitate recovery of underutilized capacity available, which may reduce or eliminate the need to build up new capacity to meet rising demands.

For example, various AC input power sources may be available at a main AC distribution point. However, a central challenge to utilizing such capacity using existing systems is that these sources typically have asynchronous phases such that they cannot be directly tied together. In some embodiments, AC power from various available AC input power sources is pulled into a HVDC bus (e.g., 240 VDC, 380 VDC, or the like) through one or more AC/DC rectifiers and sent to a PSU to power DC loads. It is contemplated herein that this technique may be more efficient and cost-effective than typical techniques for dynamically accepting power from asynchronous AC input power sources such as isolation transformers and associated components tailored for the various AC input power sources.

By way of another example, the systems and methods disclosed herein may accept power from any number of input power sources including, but not limited to, sustainable input sources (e.g., hydrogen-based sources, wind sources, solar sources, or the like) which may be DC input power sources and/or AC input power sources.

Further, various DC input power sources may directly feed power to the PSU. Further, if necessary, DC/DC converters either internal to the system or external to the system may convert DC input power from any DC input power sources to HVDC. By way of another example, a DC trunking system may accept power from any number of DC power sources and provide this power to the PSU. As a result, the PSU may be flexibly powered by any number of AC or DC input power sources.

By way of another example, the systems and methods disclosed herein may accept power directly from synchronized AC input power sources and convert this to DC load power (e.g., with one or more AC/DC rectifiers). Further, in some embodiments, a PSU may accept synchronized AC input power from one or more AC input power sources as well as DC input power from one or more DC input power sources. Power from each source may then be converted (e.g., using AC/DC rectifiers or DC/DC converters as necessary) to DC load power at a common DC load voltage.

As a result, the systems and methods disclosed herein may simultaneously enable efficient utilization of available input power to meet rising power demands and allow for seamless integration of sustainable energy sources into a power distribution network.

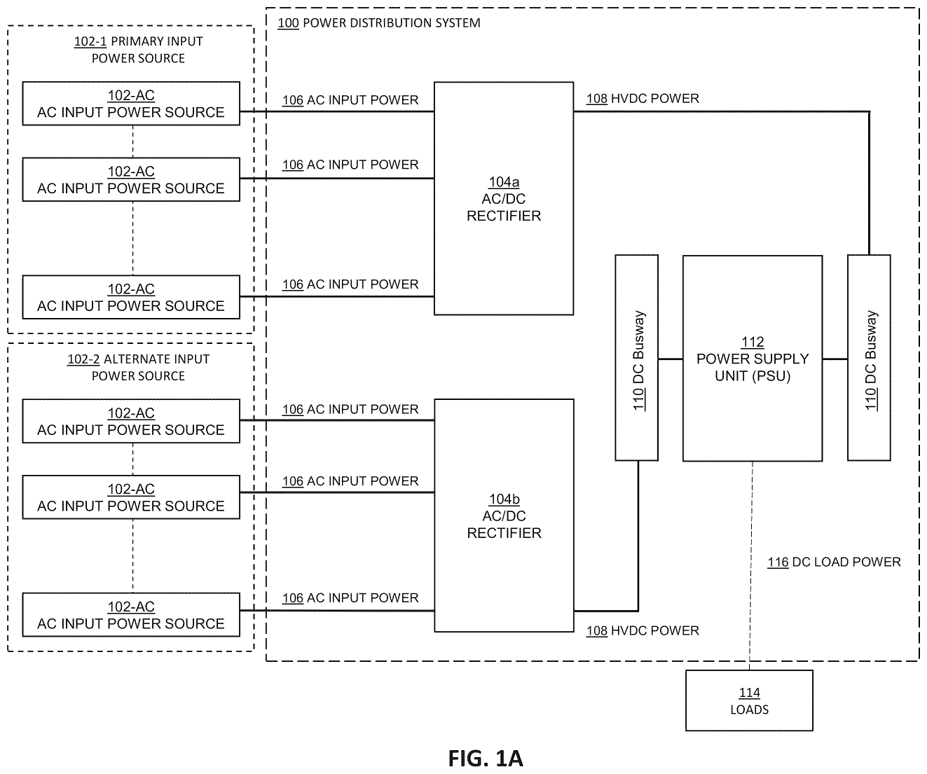

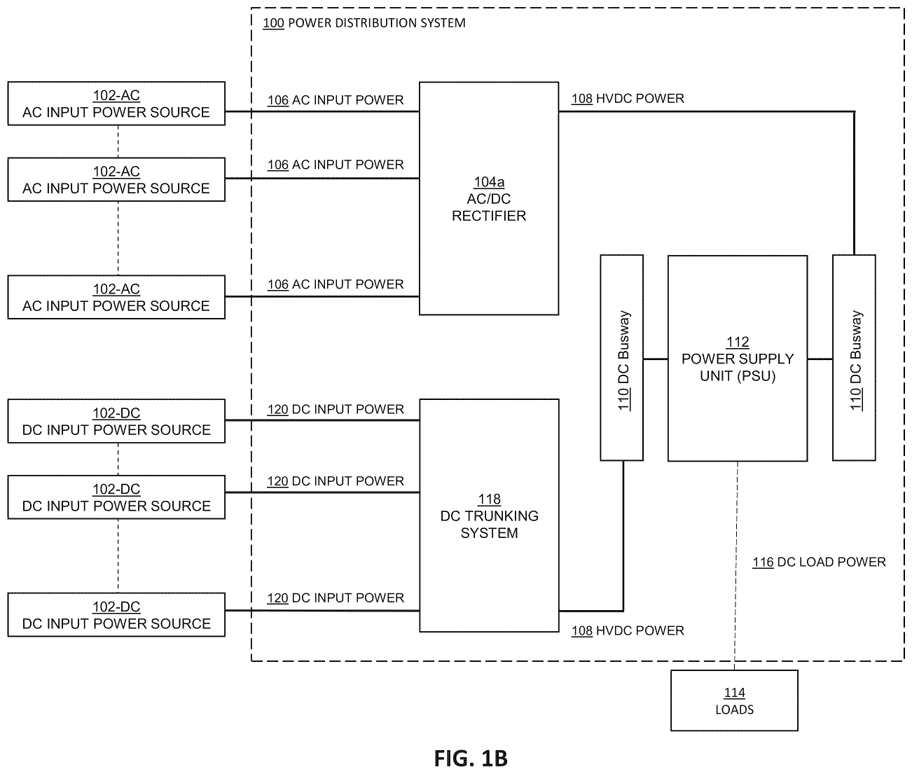

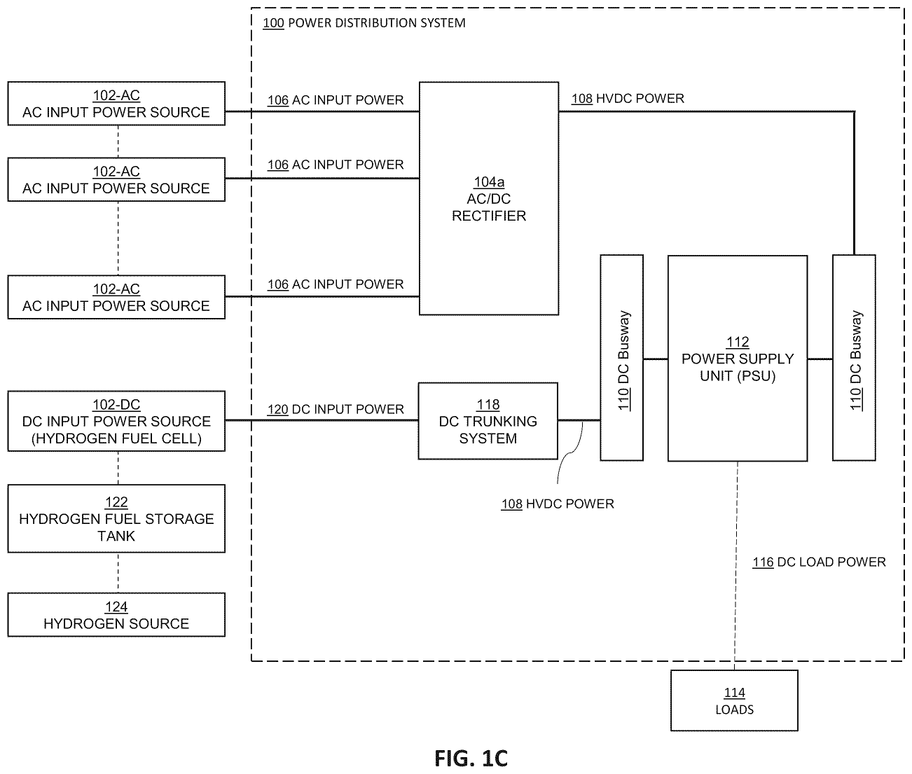

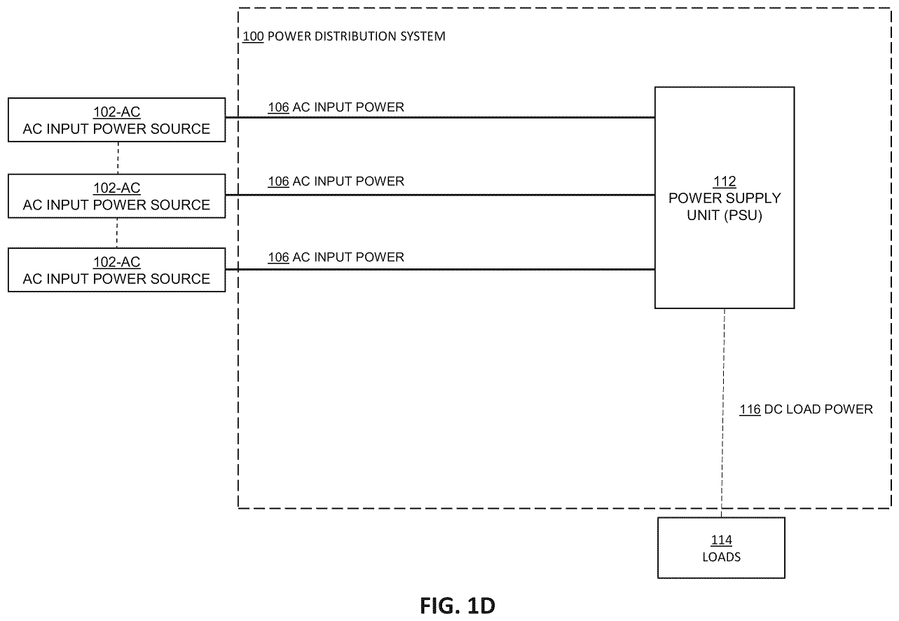

Referring now to FIGS. 1A-3, systems and methods for flexible power distribution through HVDC busways are described in greater detail, in accordance with one or more embodiments of the present disclosure. In particular, FIGS. 1A and 1B Illustrate a power distribution system 100 configured to accept power from various input power sources 102 such as AC input power sources 102-AC and DC input power sources 102-DC.

FIG. 1A is a block diagram view of a power distribution system 100 configured to accept power from multiple AC power sources, in accordance with one or more embodiments of the present disclosure.

In some embodiments, the power distribution system 100 includes one or more AC/DC rectifiers 104 to accept AC input power 106 from any number of AC input power sources 102-AC and generate HVDC power 108 at a selected HVDC voltage. In some embodiments, the HVDC power 108 is provided along one or more DC busways 110, though this is not limiting. For example, FIG. 1A illustrates a configuration including a first AC/DC rectifier 104a to accept AC input power 106 from AC input power sources 102-AC associated with a primary input power source 102-1 and a second AC/DC rectifier 104b to accept AC input power 106 from AC input power sources 102-AC associated with an alternate input power source 102-2. In this way, the AC input power sources 102-AC illustrated in FIG. 1A may correspond to AC circuits of the primary and alternate input power sources 102-1,102-2. For instance, the AC input power sources 102-AC illustrated in FIG. 1A may correspond to branched circuits with stranded capacity.

The AC input power sources 102-AC may generally provide AC input power 106 at any voltage or power level. For example, AC input power 106 may typically be provided at 480 VAC at 3 W or 415 VAC at 4 W, though these examples are illustrative only and are not limiting on the present disclosure.

The AC/DC rectifiers 104 may include any type of rectifiers known in the art suitable for converting the AC input power 106 to HVDC power 108 at a selected DC voltage level. Further, the HVDC power 108 may be provided at any voltage or power level. For example, the HVDC power 108 may be provided at 240 VDC or 380 VDC, though these examples are illustrative only and are not limiting on the present disclosure. In some embodiments, the power distribution system 100 includes multiple AC/DC rectifiers 104 to support a desired amount of capacity and/or accept AC input power 106 from multiple asynchronous AC input power sources 102-AC. In some embodiments, any AC/DC rectifier 104 may accept AC input power 106 from multiple paths (e.g., from multiple AC input power sources 102-AC or circuits thereof), where the AC input power 106 in the multiple paths may be asynchronous. As a non-limiting example, a particular AC/DC rectifier 104 (or cabinet of AC/DC rectifiers 104) may accept up to four AC input feeds and may support up to 500 KW of power. Further, any AC/DC rectifier 104 may and/or may be scalable to provide cost-efficient (e.g., lowest cost) conversion.

It is contemplated herein that the use of one or more AC/DC rectifiers 104 to accept AC input power 106 from multiple AC input power sources 102-AC and provide HVDC power 108 output enables the flexible, dynamic, and efficient utilization of AC input power 106 from multiple asynchronous AC input power sources 102-AC.

In some embodiments, the power distribution system 100 includes at least one power supply unit (PSU) 112 to receive the HVDC power 108. Each PSU 112 may then distribute power (e.g., DC load power 116) to various loads 114 at any selected DC load voltage which may be, but is not required to be lower than a voltage associated with the HVDC power 108. The DC load power 116 may generally have any characteristics (e.g., voltage, current, or the like) suitable for powering selected loads 114. As one non-limiting illustration, the DC load power 116 may have a DC load voltage of 48 VDC. A PSU 112 may include any components or combinations of components suitable for converting the HVDC power 108 to the DC load power 116 such as, but not limited to, one or more DC/DC converters or one or more AC/DC rectifiers. A PSU 112 may further include any components or combinations of components suitable for receiving DC power (e.g., HVDC power 108) and distributing this DC power to one or more loads 114 such as, but not limited to, a unipolar (e.g., 2-wire) or a bipolar (3-wire) DC distribution system. Further, a PSU 112 may have any distribution structure. In this way, the PSU 112 may be fed at one end, fed at both ends, fed in the center, or may be a ring distributor. A PSU 112 may further include load distribution or selection circuitry to selectively power any combination of connected loads 114 and/or selectively block (e.g., disconnect) any of the loads 114. It is to be understood that the illustration of a single PSU 112 in FIG. 1A is provided solely for illustrative purposes and should not be interpreted as limiting on the present disclosure. Rather, the power distribution system 100 may generally include any number of PSUs 112 connected to respective loads 114. Further, each of these PSUs 112 may accept HVDC power 108 either directly or through DC busways 110.

The loads 114 may be any device known in the art, including, but not limited to a network appliance. In some embodiments, the network appliance includes at least one of a network switch. In another embodiment, the network appliance includes a server.

A PSU 112 may include any number of input ports to accept the HVDC power 108. In some embodiments, as illustrated in FIG. 1A, a PSU 112 includes two input ports. For example, as illustrated in FIG. 1A, the PSU 112 may include two input ports to receive HVDC power 108 from two DC busways 110. In some embodiments, a PSU 112 includes a single input port. Further, one or more PSUs 112 may be suitable for accepting HVDC power 108 with multiple different voltage values either simultaneously or by selection (e.g., by a user or analysis of incident HVDC power 108). For example, it may be the case that different input power sources 102 (or AC/DC rectifiers 104) may provide HVDC power 108 with different voltage values. In this way, one or more PSUs 112 may convert HVDC power 108 with these different DC voltages and convert this power to DC load power 116 having a single DC load voltage. In some embodiments, a single PSU 112 is configured to convert HVDC power 108 with two or more voltages to a common DC load voltage. In some embodiments, different PSUs 112 are configured to convert HVDC power 108 with different voltages to the common DC load voltage. Further, in some embodiments, one or more PSUs 112 may provide the DC load power 116 with different DC load voltages to power different loads 114. In this way, one or more PSUs 112 may flexibly convert HVDC power 108 to DC load power 116 suitable for powering any selected loads 114.

A PSU 112 may support a variety of features or connection options such as, but not limited to, positive and/or negative output ground options, AC input phase current balancing, peak shaving, or multiple efficiency modes. Additionally, a PSU 112 may include or may be communicatively coupled with a controller (not shown) to facilitate various aspects of the operation such as, but not limited to, load control, efficiency, or the like.

A PSU 112 may generally support any amount of power. In some embodiments, a PSU 112 supports 3,200 Watts. In some embodiments, a PSU 112 supports 4,200 W. However, it is to be understood that these examples are illustrative only and are not limiting on the present disclosure. In some embodiments, the power distribution system 100 includes multiple PSUs 112 to provide any desired amount of load capacity. For example, the power distribution system 100 may include one or more DC shelves to mount and/or connect multiple PSUs 112 in a rack. In some embodiments, the power distribution system 100 includes nine 3,200 W PSUs 112 to provide 25 KW of power per rack with an HVDC power 108 at 240 VDC or 380 VDC. In some embodiments, the power distribution system 100 includes twenty 3,200 W PSUs 112 to provide 60 KW of power per rack with an HVDC power 108 at 240 VDC or 380 VDC. In some embodiments, the power distribution system 100 includes twenty-three 4,200 W PSUs 112 to provide 90 KW of power per rack with an HVDC power 108 at 240 VDC or 380 VDC.

Referring generally to FIG. 1A, it is contemplated herein that the power distribution system 100 may enable the recovery of underutilized input power capacity. For example, the AC input power sources 102-AC illustrated in FIG. 1A may correspond to branched circuits with stranded or underutilized capacity. However, the power distribution system 100 may provide dynamic utilization of AC input power 106 from any of the AC input power sources 102-AC from either the primary or alternate input power sources 102-1,102-2. As a result, the available AC input power 106 may be efficiently utilized. Further, ability to dynamically utilize AC input power 106 from any of the available sources may facilitate reliable power delivery to the loads 114 in the event of a failure or interruption of any of the AC input power sources 102-AC.

Referring now to FIG. 1B, FIG. 1B is block diagram view of a power distribution system 100 configured to accept power from multiple AC and/or DC input power sources 102, in accordance with one or more embodiments of the present disclosure. As was described with respect to FIG. 1A, although only a single PSU 112 is illustrated, the power distribution system 100 may generally include any number of PSUs 112 connected to any number of respective loads 114.

In some embodiments, any PSU 112 may accept DC input power 120 from one or more DC input power sources 102-DC. In some embodiments, a DC input power source 102-DC provides HVDC power 108 either directly or through one or more DC/DC converters (not shown) which may be internal or external to the system. In some embodiments, the power distribution system 100 further includes a DC trunking system 118 to accept DC input power 120 from any number of DC input power sources 102-DC and provide this to a PSU 112 (e.g., via one or more DC busways 110). For example, the DC trunking system 118 may include one or more DC/DC converters to convert DC power from the DC input power sources 102-DC to the HVDC levels received by the PSU 112. In this way, the PSU 112 may flexibly receive HVDC power 108 from any number of AC or DC input power sources 102 and distribute this power as necessary to various loads 114.

The power distribution system 100 may generally accept DC input power 120 from any type of DC input power sources 102-DC known in the art including, but not limited to, sustainable power sources. For example, FIG. 1C is block diagram view of a power distribution system 100 in which at least one DC input power source 102-DC is formed as a hydrogen fuel cell, in accordance with one or more embodiments of the present disclosure. FIG. 1C further illustrates supporting components such as a hydrogen fuel storage tank 122 and a hydrogen source 124 (e.g., a hydrolyzer, or other source). However, it is to be understood that the power distribution system 100 may accept DC input power 120 from any sustainable input power source such as, but not limited to, a wind source or a solar source.

It is contemplated herein that the systems and methods disclosed herein may facilitate a dynamic utilization of any combination of traditional AC input power sources 102-AC and DC input power sources 102-DC such as, but not limited to, sustainable input power sources. In particular, the PSU 112 may dynamically utilize power from any available power source since the power provided by all input power sources 102 is converted HVDC power 108 (e.g., with a common voltage level). Further, the systems and methods disclosed herein may facilitate a gradual transition to Increasingly sustainable input power sources as desired.

In some embodiments, a DC input power source 102-DC includes one or more energy storage devices such as, but not limited to, batteries. In this way, the energy storage devices may be placed on a DC busway 110 and may provide holdup time in the event that any of the other input power sources 102 are unavailable. As an example including sustainable energy input power sources 102, the energy storage devices may temporarily sustain the loads 114 if the sustainable energy input power sources 102 are unable to, without the need to draw on fossil fuel input power sources 102 (e.g., grid power, standby generators, or the like).

Further, in some embodiments, although not shown, a PSU 112 may directly accept phase-synchronized AC input power 106 from any number of AC input power sources 102-AC. Since the AC input power 106 from these sources is synchronized, no conversion to HVDC power 108 is necessary. FIG. 1D is block diagram view of a power distribution system configured to accept AC input power 106 from multiple synchronous AC input power sources 102-AC, in accordance with one or more embodiments of the present disclosure. Additionally, in some embodiments, a PSU 112 may accept both synchronous AC input power 106 from synchronous AC input power sources 102-AC and DC input power 120 from one or more DC input power sources 102-DC. Such a configuration may correspond to a combination of FIG. 1D with any of FIGS. 1A-1C. In some cases, a power distribution system 100 may further include one or more AC/DC rectifiers 104 to convert additional asynchronized AC input power 106 to HVDC power 108.

Referring generally to FIGS. 1A-1D, any particular PSU 112 may accept power from any combination of AC input power sources 102-AC or DC input power sources 102-DC (e.g., AC input power sources 102-AC only, DC input power sources 102-DC only, or a combination thereof). Further, a PSU 112 may prioritize certain input power sources 102 over others. For example, a PSU 112 may prioritize sustainable energy input power sources 102 over fossil fuel input power sources 102.

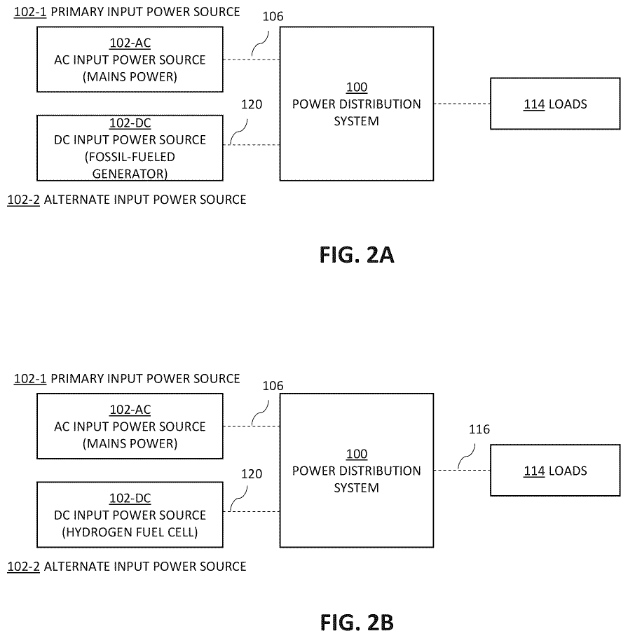

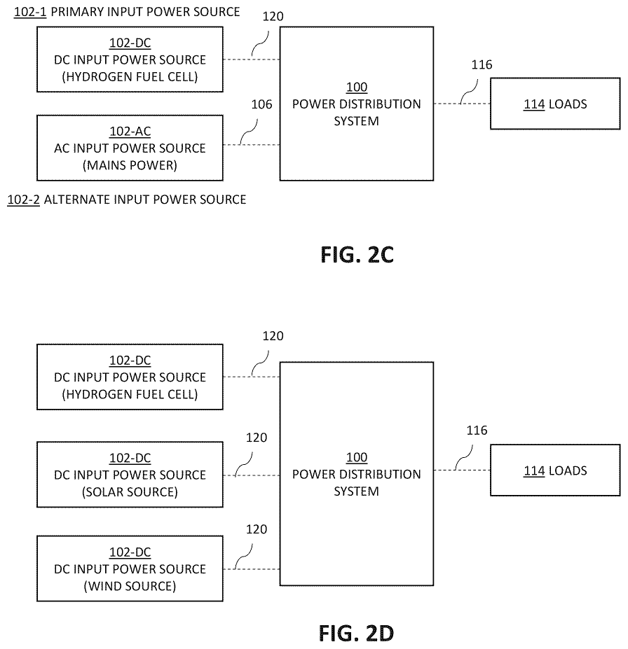

FIGS. 2A-2D illustrate four non-limiting implementations of the power distribution system 100 with different input power sources 102.

FIG. 2A is a conceptual view of a power distribution system 100 powered by mains power as a primary input power source 102-1 (e.g., an AC input power source 102-AC) and a fossil-fuel powered generator as an alternate input power source 102-2 (e.g., a DC input power source 102-DC), in accordance with one or more embodiments of the present disclosure. For example, although the alternate input power source 102-2 is shown here as an AC input power source 102-AC, this is merely illustrative. More generally, the alternate input power source 102-2 may generate AC or DC power such that the depiction in FIG. 2A may correspond to an implementation of either FIG. 1A or 1B.

FIG. 2B is a conceptual view of a power distribution system 100 powered by mains power as a primary input power source 102-1 (e.g., an AC input power source 102-AC) and a hydrogen fuel cell as an alternate input power source 102-2 (e.g., a DC input power source 102-DC), in accordance with one or more embodiments of the present disclosure. In this way, the power distribution system 100 illustrated in FIG. 2B may represent a first step in a transition to fully-sustainable input power sources 102.

FIG. 2C is a conceptual view of a power distribution system 100 powered by a hydrogen fuel cell as a primary input power source 102-1 (e.g., a DC input power source 102-DC) and mains power as an alternate input power source 102-2 (e.g., an AC input power source 102-AC), in accordance with one or more embodiments of the present disclosure. In this way, FIG. 2C may represent a second step in a transition to fully-sustainable input power sources 102. Further, it is noted that the systems in FIGS. 2B and 2C may be substantially similar such that the transition between FIGS. 2B and 2C may be merely a matter of availability and reliability of the respective input power sources 102.

FIG. 2D is a conceptual view of a power distribution system 100 powered by multiple sustainable input power sources 102, in accordance with one or more embodiments of the present disclosure. In particular, FIG. 2D illustrates a power distribution system 100 powered by a hydrogen fuel cell, a solar source, and a wind source. In this way, FIG. 2D may represent a final step in a transition to fully-sustainable input power sources 102.

Referring generally to FIGS. 1A-2D, it is contemplated herein that a particular implementation of the power distribution system 100 may be simultaneously suitable for any of any of the configurations illustrated in FIGS. 1A-2D. In this way, the power distribution system 100 as disclosed herein may provide a dynamic and flexible power distribution platform.

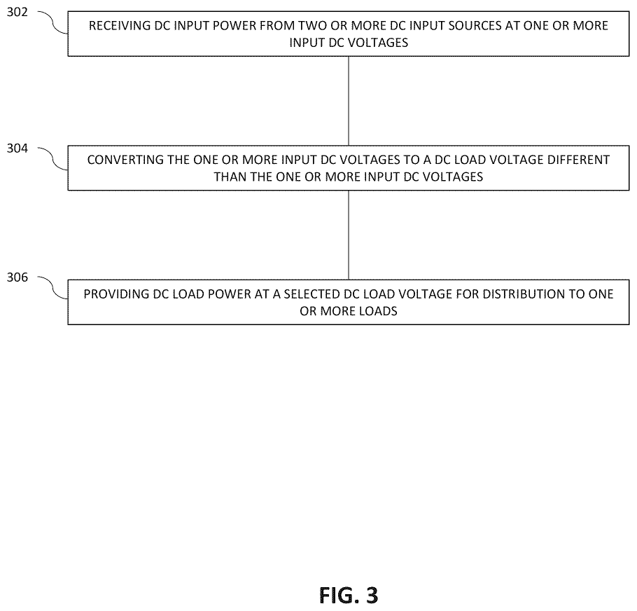

FIG. 3 is a flow diagram illustrating steps performed in a method 300 for power distribution, in accordance with one or more embodiments of the present disclosure. Applicant notes that the embodiments and enabling technologies described previously herein in the context of the power distribution system 100 should be interpreted to extend to the method 300. It is further noted, however, that the method 300 is not limited to the architecture of the power distribution system 100.

In some embodiments, the method 300 includes a step 302 of receiving (e.g., with one or more PSUs 112) DC input power (e.g., HVDC power 108) from two or more DC input power sources 102-DC at one or more input DC voltages. The DC input power sources 102-DC may generally include any combination of DC input power sources 102-DC or AC/DC rectifiers 104 providing DC input power 120 (e.g., HVDC power 108) from rectified AC input power 106.

In some embodiments, the method 300 includes a step 304 of converting (e.g., with the one or more PSUs 112) the one or more input DC voltages to a DC load voltage different than the one or more input DC voltages. For example, the step 304 may include providing a DC/DC conversion of the one or more input DC voltages to the DC load voltage.

In some embodiments, the method 300 includes a step 306 of providing (e.g., with the one or more PSUs 112) DC load power 116 at a selected DC load voltage for distribution to one or more loads 114. For example, the step 306 may include distributing the DC load power 116 using any DC distribution system known in the art such as, but not limited to, a 2-wire or a 3-wire DC distribution system.

Referring generally to FIG. 3, the method 300 may thus enable flexible power distribution to one or more loads 114 based on any combination of AC input sources 102-AC or DC input power sources 102-DC. In particular, the method 300 may enable seamless power delivery from multiple asynchronous AC input sources 102-AC alone or in combination with DC input power sources 102-DC such as, but not limited to, sustainable energy sources. Further, the method 300 avoids the need for isolation transformers in the case of asynchronous AC input sources 102-AC.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A power distribution system comprising:
one or more power supply units configured to accept direct current (DC) input power from two or more DC input power sources and provide output DC power at a DC load voltage for distribution to one or more loads, wherein the DC input power is provided at one or more input DC voltages different than the DC load voltage, wherein the one or more power supply units include one or more DC/DC converters to convert the DC input power to the DC load voltage; and
one or more alternating current (AC) to DC rectifiers (AC/DC rectifiers) configured to convert AC input power from one or more AC input power sources to at least one of the one or more input DC voltages, wherein each of the one or more AC/DC rectifiers is connected to at least one of the one or more power supply units as one of the two or more DC input power sources.

2. The power distribution system of claim 1, wherein the one or more AC input power sources include two or more AC input power sources.

3. The power distribution system of claim 2, wherein the AC input power from at least some of the two or more AC input power sources have asynchronous phases.

4. The power distribution system of claim 2, wherein the AC input power from at least some of the two or more AC input power sources have different AC voltages.

5. The power distribution system of claim 2, wherein the two or more AC input power sources include one or more primary AC input power sources and one or more alternate AC input power sources.

6. The power distribution system of claim 1, wherein the one or more AC input power sources provide the AC input power with at least one of 480 VAC or 415 VAC.

7. The power distribution system of claim 1, wherein at least one of the two or more DC input power source comprises:
at least one of a fuel cell source, a wind fuel source, or a solar fuel source.

8. The power distribution system of claim 1, wherein the one or more input DC voltages include one or more high voltage direct current (HVDC) voltages.

9. The power distribution system of claim 1, wherein the one or more input DC voltages include at least one of 380 VDC or 240 VDC.

10. The power distribution system of claim 1, wherein the DC load voltage is lower than the one or more input DC voltages.

11. The power distribution system of claim 1, wherein the DC load voltage is at least one of 48 VDC or 240 VDC.

12. The power distribution system of claim 1, wherein at least one of the one or more power supply units comprises:
at least one of a 2-wire DC distribution system or a 3-wire DC distribution system.

13. The power distribution system of claim 1, further comprising:
a DC trunking system configured to receive DC power from at least some of the two or more DC input power sources, wherein the DC trunking system is connected to at least one of the one or more power supply units as one of the two or more DC input power sources.

14. The power distribution system of claim 1, further comprising:
one or more DC busways between at least one of the two or more DC input power sources and at least one of the one or more power supply units.

15. The power distribution system of claim 1, wherein at least one of the one or more loads comprises:
a network appliance.

16. The power distribution system of claim 15, wherein the network appliance comprises:
at least one of a network switch or a server.

17. A power distribution method comprising:
receiving, with one or more power supply units, direct current (DC) input power from two or more DC input power sources at one or more input DC voltages, wherein at least one of the two or more DC input power sources is an alternating current (AC) to DC rectifier (AC/DC rectifier) configured to convert AC input power from one or more AC input power sources to at least one of the one or more input DC voltages;
converting, with the one or more power supply units, the one or more input DC voltages to a DC load voltage different than the one or more input DC voltages; and
providing, with the one or more power supply units, output DC power at the DC load voltage for distribution to one or more loads.

18. The power distribution method of claim 17, wherein the one or more AC input power sources include two or more AC input power sources with asynchronous phases.

19. The power distribution method of claim 17, wherein at least one of the two or more input DC power sources is a DC input power source comprising:
at least one of a hydrogen fuel source, a wind fuel source, or a solar fuel source.

20. A power distribution system comprising:
one or more power supply units configured to accept at least one of DC input power from one or more DC input power sources at one or more input DC voltages or synchronous alternating current (AC) input power from one or more AC input sources and provide output DC power at a DC load voltage for distribution to one or more loads, wherein the one or more power supply units include at least of one or more DC/DC converters to convert the DC input power to the DC load voltage or one or more AC/DC rectifiers to convert the synchronous AC input power to the DC load voltage.
